(19) United States
(12) Patent Application Publication
(10) Pub. No.: US 2025/0239628 A1
(43) Pub. Date: Jul. 24, 2025

(54) AMORPHOUS CARBON GRAPHITIC STRUCTURE PRECURSORS

(71) Applicant: Robert Bosch GmbH, Stuttgart (DE)

(72) Inventors: Ji QI, Watertown, MA (US); Karim GADELRAB, Boston, MA (US); Nicola MOLINARI, Somerville, MA (US)

(21) Appl. No.: 18/419,116

(22) Filed: Jan. 22, 2024

(51) Int. Cl. H01M 4/92; C01B 32/205

(52) U.S. Cl. CPC H01M 4/926; C01B 32/205; C01P 2002/02

(57) ABSTRACT

Carbon precursors for use in fabricating carbon supports with a graphitic structure. The carbon precursor may include defective amorphous carbon spheres having a mass loss percentage compared to defect-free amorphous carbon spheres. The defective amorphous carbon spheres are capable of forming a single-layer graphitic structure for use as the carbon support. The carbon graphitic structure precursor may include amorphous carbon nanoclusters having a nominal nanocluster diameter of less than 3 nanometers. The amorphous carbon nanoclusters are capable of forming a single-layer graphitic structure for use as the carbon support.

### TECHNICAL FIELD

The present disclosure relates to amorphous carbon graphitic structure precursors (e.g., amorphous carbon single-layer graphitic structure precursors). The amorphous carbon graphitic structure precursors may be used to form single-layer graphitic structures for use as catalyst supports in proton exchange membrane fuel cells (PEMFCs) and other electrochemical cells.

### BACKGROUND

Proton exchange membrane fuel cells (PEMFCs) are an environmentally friendly energy conversion device. Utilizing an electrochemical reaction of H₂ and O₂ gases, PEMFCs provide a practical energy efficiency of over 60% with H₂O as the only product. The fast diffusion of H-ions enables functional operation of the PEMFC at a relatively low temperature of about 100° C. In contrast, solid oxide fuel cells and molten carbonate fuel cells operate at about 600° C. and above.

Despite the benefits of PEMFCs, their high production price and relatively poor durability are limiting their application in energy plants and more affordable transportation technologies. For example, the platinum (Pt)/carbon (C) electrocatalysts in PEMFC cathodes cost at least half of the production price of a PEMFC, while the electrochemically active surface area (ECSA) of a Pt catalyst degrades severely (e.g., 50% or greater) during cycling.

### SUMMARY

In an embodiment, a carbon precursor for use in fabricating a carbon support with a graphitic structure is disclosed. The carbon precursor includes defective amorphous carbon spheres having a mass loss percentage compared to defect-free amorphous carbon spheres. The defective amorphous carbon spheres are capable of forming a single-layer graphitic structure for use as the carbon support.

When the defect-free amorphous carbon spheres' density is less than 2.5 g/cm³, the mass loss percentage may be greater than 70%. When the defect-free amorphous carbon spheres' density is greater than 2.5 g/cm³, the mass loss percentage may be greater than 80%. The defective amorphous carbon spheres may include defects (e.g., cylindrical defects). The defective amorphous carbon spheres may be defective amorphous carbon nanospheres. The defect-free amorphous carbon spheres may include hollow spheres. The defective amorphous carbon spheres may include micropores of lower than 2 nanometers in a range of 0.5 to 2.0 cm³/g.

In another embodiment, a carbon precursor for use in fabricating a carbon support with a graphitic structure is disclosed. The carbon precursor includes amorphous carbon nanoclusters having a nominal nanocluster diameter of less than 3 nanometers. The amorphous carbon nanoclusters may be capable of forming a single-layer graphitic structure for use as a carbon support.

The amorphous carbon nanoclusters may have an amorphous carbon nanocluster density of 1 to 1.6 g/cm³. When the amorphous carbon nanoclusters have an amorphous carbon nanocluster density of 1.6 to 2.4 g/cm³, the nominal nanocluster diameter may be less than 2 nanometers. When the amorphous carbon nanoclusters have an amorphous carbon nanocluster density of 2.4 to 3.0 g/cm³, the nominal nanocluster diameter may be less than 1.6 nanometers. The amorphous carbon nanoclusters may include defects.

In yet another embodiment, a method of fabricating a single-layer graphitic structure for use as a carbon support is disclosed. The method may include annealing amorphous carbon spheres to form a single-layer graphitic structure and forming the single-layer graphitic structure into the carbon support.

When the amorphous carbon spheres are defective amorphous carbon spheres, the method may further include forming the defective amorphous carbon spheres from starting amorphous carbon spheres. The forming step may include reducing the mass of the starting carbon spheres by a mass loss percentage to obtain the defective amorphous carbon spheres. The step may include ion bombarding the starting carbon spheres. The forming step may include corroding the starting carbon spheres. The single-layer graphitic structure may be a single-layer graphitic shell. The carbon support may be configured to support an electrocatalyst.

### BRIEF DESCRIPTION OF THE DRAWINGS

FIG. 1 depicts a schematic, side view of certain components of a proton exchange membrane fuel cell (PEMFC) according to one embodiment.

FIG. 2A depicts a schematic view of an amorphous carbon solid sphere graphitized into a graphitic carbon nano-onion.

FIG. 2B depicts a schematic view of an amorphous carbon hollow sphere graphitized into a single-layer graphitic carbon hollow shell.

FIG. 3A is a graph showing a distribution of the number of carbon per volume versus distance to the center of the graphitic carbon nano-onion shown in FIG. 2A with different initial radii (i.e., about 6 Å and about 10 Å) and an initial density of 2.97 g/cm³.

FIG. 3B is a graph showing an evolution of surface area of nano-onion solid spheres and hollow spheres with different initial radii and an initial density of 2.97 g/cm³.

FIG. 4A is a graph showing surface area of nano-onion solid spheres and hollow spheres as a function of initial sphere radius with a density of 1.55 g/cm³.

FIG. 4B is a graph showing surface area of nano-onion solid spheres and hollow spheres as a function of initial sphere radius with a density of 2.44 g/cm³.

FIG. 5 depicts a graph of surface areas of graphitized carbon spheres with different mass loss.

FIG. 6 depicts a schematic view of amorphous carbon spheres with cylindrical defects with a mass reduction of over 70% graphitized into single-layer graphitic carbon nanoclusters.

FIG. 7A depicts a schematic view of amorphous carbon spheres with a radius of about 0.8 nm graphitized into single-layer graphitic carbon nanoclusters.

FIG. 7B depicts a schematic view of amorphous carbon spheres with a radius of about 1.0 nm graphitized into double-layer graphitic carbon nanoclusters.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within ±5% of the value. As one example, the phrase “about 100” denotes a range of 100±5, i.e. the range from 95 to 105. Generally, when the term “about” is used, it can be expected that similar results or effects according to the invention can be obtained within a range of ±5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1 to 10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1 to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

As used herein, the term “and/or” means that either all or only one of the elements of said group may be present. For example, “A and/or B” means “only A, or only B, or both A and B”. In the case of “only A”, the term also covers the possibility that B is absent, i.e., “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Platinum (Pt)/carbon (C) cathode electrocatalysts may cost at least half the manufacturing price of commercial proton exchange membrane fuel cell (PEMFC), and its degradation over cycling limits the lifetime of PEMFC. Price may be decreased with less amount of Pt loading while keeping a high electrochemically active surface area of Pt catalyst by using high surface area carbon as a substrate.

Optimizing the microstructure of a carbon support for a Pt catalyst is a promising step for improving the durability of a PEMFC and decreasing the cost thereof. A correlation of the surface area of a carbon support with the ECSA of a Pt catalyst deposited on a carbon support may be considered in the optimizing step. For instance, the larger the surface area of the carbon support, the larger the ECSA of Pt catalysts deposited on the carbon support, when the same weight percentage of Pt loading is applied. This trend may be attributed to the uniformly small (e.g., a mean diameter of about 3 nm) size and an even distribution of Pt nanoparticles on carbon support with a relatively high surface area. Though a Pt/C electrocatalyst with a high surface area carbon (HSAC) achieves a relatively high ECSA with a lower amount of Pt loading, Pt/C electrocatalysts with HSAC still suffer from the same or similar severe degradation in ECSA during cycling as Pt/C electrocatalysts with low surface area carbon (LSAC). One proposal to improve cycle stability of Pt/C is to replace oxidative amorphous carbon with less reactive graphitized carbon.

One proposal to fabricate graphitic carbon with a very high surface area includes a silver templating method. According to this method, a mesoporous carbon nano-dendrite (MCND) structure is synthesized to have primary particles with bubble-like hollow graphitic carbon nanoparticles (HGCNs) with surface pores. While typical HGCNs have a wall thickness over 5 nm (e.g., over 10 graphite layers), a MCND structure may have a single-layer graphene wall, thereby leading to a very high surface area (e.g., 1,610 m²/g).

While the MCND structure has shown promise as a very high surface area carbon support, a need continues to exist to fabricate graphitic carbon nanoparticles with a very high surface area. Moreover, durability may be improved by replacing amorphous carbon with graphitic carbon, which is less oxidative.

In one or more embodiments, carbon precursors are disclosed to fabricate graphitic carbon nanoparticles with a single-layer graphitic structure (e.g., graphitic shell or wall) having a very high surface area. Single-layer may refer to one layer of a two-dimensional material (e.g., graphite). Shells or walls may refer to a single-layer structure that extends in three-dimensions.

Graphitic carbon nanoparticles may refer to carbon nanoparticles having one or more graphite materials (e.g., a crystalline form of carbon atoms formed in hexagonal structures) present. The one or more graphite materials may be formed from one or more graphene materials. In one or more embodiments, the carbon nanoparticles may be entirely graphitic, meaning that 100% of the carbon nanoparticles include the one or more graphite materials. The high surface area may be in a range of 500 to 3,000 m²/g, and in other embodiments, a range of 1,400 m²/g and above (e.g., 1,400 to 3,000 m²/g).

In one or more embodiments, precursor carbon structures are disclosed that can be fabricated into single-layer graphitic carbon mesostructures that possess both desirable features and mitigate the degradation and price issues of Pt/C electrocatalysts in PEMFC. Carbon mesostructures may refer to structures in a mesoscale range between a microscopic range and a macroscopic range. The mesoscale range may be from nanometers (10-9 meters) and micrometers (106 meters). The precursor carbon structures may include an amorphous carbon structure. Amorphous carbon structures may refer to a disordered or random arrangement of carbon atoms (e.g., lacking a well-defined crystalline structure). The carbon structure may be entirely amorphous. The single-layer graphitic material may include carbon nanoclusters. Carbon nanostructures may refer to carbon materials having one or more dimensions in a nanoscale range (e.g., a range of 1 to 100 nanometers). These structures may also be utilized to synthesize carbon structures for other applications specifying high surface area and good durability, such as anode materials for alkali-ion batteries.

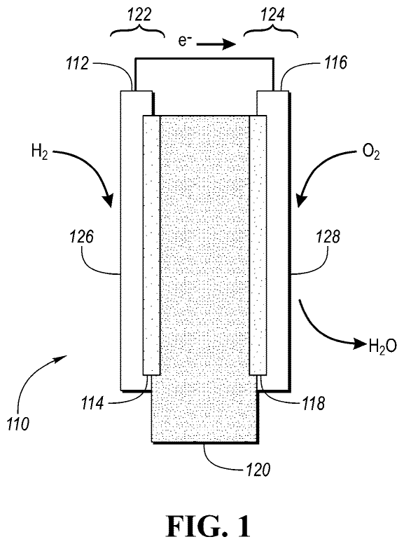

FIG. 1 depicts a schematic, side view of certain components of PEMFC 110 according to one embodiment. As shown in FIG. 1, PEMFC 110 includes anode catalyst support 112 coated with anode catalyst layer 114 formed of an anode catalyst material and cathode catalyst support 16 coated with cathode catalyst layer 118 formed of a cathode catalyst material. Polymer electrolyte material (PEM) 120 extends between anode catalyst support 112 and cathode catalyst support 116. The cathode catalyst material may be dispersed at an interface of PEM 120 and a current collector (not shown) supported by cathode catalyst support 118. The current collector may be a porous carbon current collector. Anode catalyst layer 114 is positioned between anode catalyst support 112 and PEM 120. Cathode catalyst layer 118 is positioned between cathode catalyst support 116 and PEM 120. Anode 122 may generally refer to anode catalyst support 112 and anode catalyst layer 114. Cathode 124 may generally refer to cathode catalyst support 116, cathode catalyst layer 118, and the current collector (not shown). PEMFC 110 also includes first and second gas diffusion layers (GDLs) (not shown). First GDL is adjacent outer surface 126 of anode catalyst support 112 and second GDL is adjacent outer surface 128 of cathode catalyst support 116.

In one or more embodiments, precursor carbon structures are disclosed that undergo graphitization at an elevated temperature (e.g., 3,000 K) to form carbon nanoparticles with single-layer graphitic walls. These precursor carbon structures may be confirmed through molecular dynamics simulations in the graphitization of amorphous carbon nanoparticles at the elevated temperature.

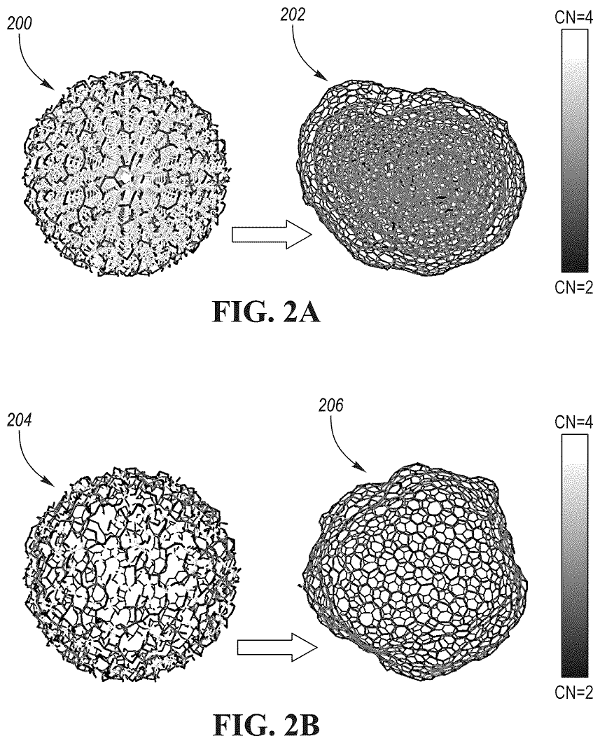

FIG. 2A depicts a schematic view of amorphous carbon solid sphere 200 graphitized into graphitic carbon nano-onion 202 by annealing at about 3,000 K. The term nano-onion may refer to nested (e.g., concentric) carbon graphitic structures. FIG. 2B depicts a schematic view of amorphous carbon hollow sphere 204 graphitized into single-layer graphitic carbon hollow shell 206 by annealing at about 3,000 K. The graphitization of the solid and hollow amorphous carbon nano-spheres occurs with a carbon environment comparable to that of an amorphous carbon with a density of 2.97 g/cm³ and an average coordination number (CN) of 3.85. As shown in FIG. 2A, starting carbons with a solid sphere result in a graphitic but onion-like shape, which may be undesirable because the onion shape reduces the available surface area of the carbon. For instance, the inner layers of graphitic carbon nano-onion 202 may be inaccessible for certain applications (e.g., platinum deposition) with an average CN close to 3 at about 3,000 K.

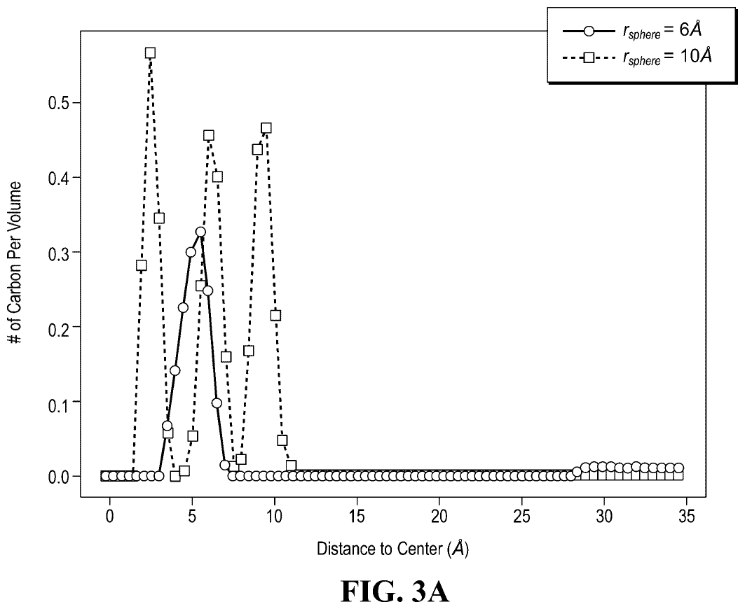

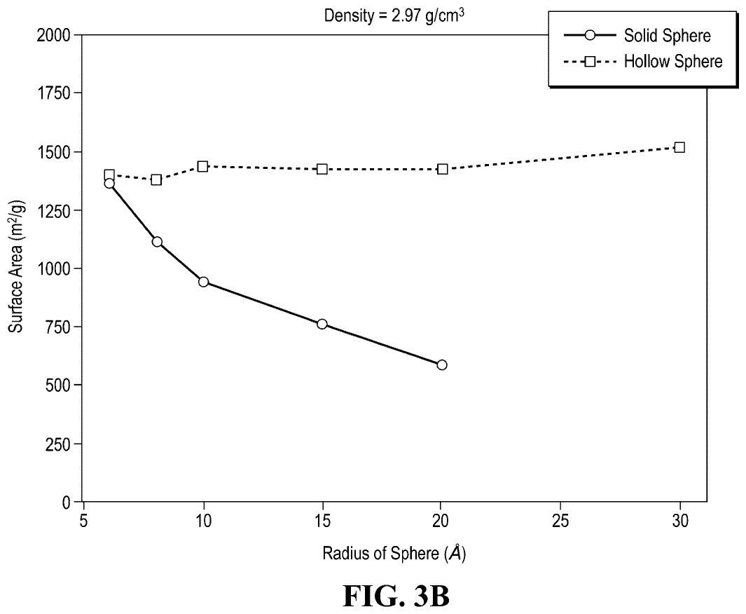

FIG. 3A is a graph showing a distribution of a number of carbon per volume versus distance to the center of the graphitic carbon nano-onion shown in FIG. 2A with different initial radii (i.e., about 6 Å and about 10 Å) and an initial density of 2.97 g/cm³. When starting with smaller radii (e.g., about 6 Å), the structure after the annealing is composed of a single layer carbon. Larger radii (e.g., about 10 Å) results in a multi-layered graphitic structure. As shown in FIG. 3A, the intervals between peaks of the number of carbon per volume versus the distance to the center of the sphere curve range from about 0.3 to 0.4 nm. This range matches with an experimentally measured interlayer distance between graphite layers (0.335 nm). In contrast, as shown in FIG. 2B, amorphous carbon hollow spheres graphitize into single-wall graphitic shells. The differences in the characteristics between graphitic solid spheres and graphitic hollow spheres may lead to significant differences in surface areas.

FIG. 3B is a graph showing an evolution of surface area of nano-onion solid spheres and hollow spheres with different initial radii and an initial density of 2.97 g/cm³. FIG. 3B supports that starting from any dimension depicted of a hollow carbon (e.g., about 6 Å to about 30 Å) results in a carbon precursor of one or more embodiments. FIG. 3B also supports that a non-hollow carbon cluster less than a certain radius (e.g., about 6A) results in a carbon precursor of one or more embodiments. As shown in FIG. 3B, the surface area of graphitic solid spheres at 3,000 K drops inversely proportionate with the radius of the amorphous carbon spherical precursors, while the surface area of graphitic spheres remains unchanged at above 1,400 m²/g.

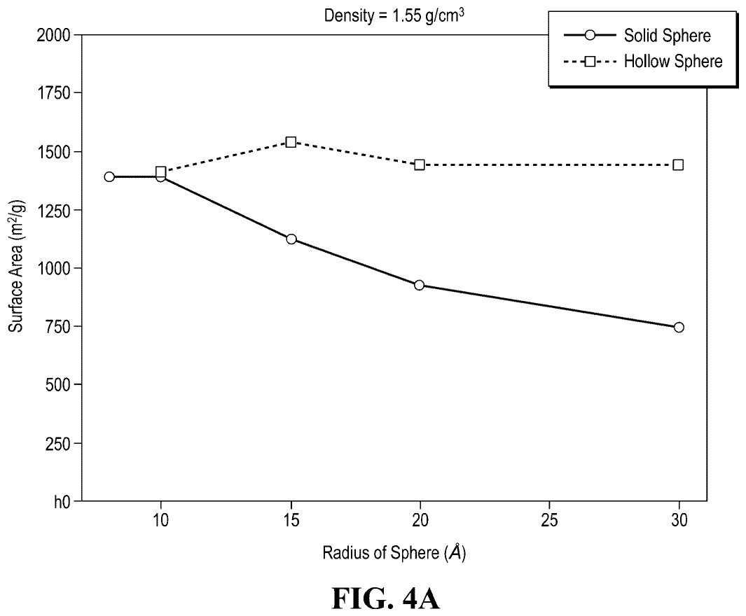

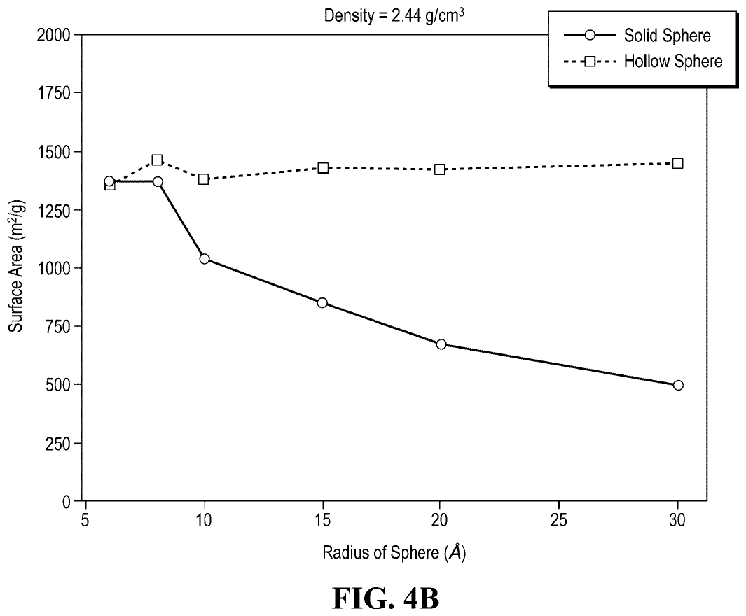

The graphitization of amorphous carbon nanoparticles may also be observed in simulations with two other models with experimentally reported densities and respective averaged CN. The first model may use 1.55 g/cm³ and a CN equal to 2.97. FIG. 4A is a graph showing surface area of nano-onion solid spheres and hollow spheres as a function of initial sphere radius with a density of 1.55 g/cm³. The second model may use 2.44 g/cm³ and CN equal to 3.33. FIG. 4B is a graph showing surface area of nano-onion solid spheres and hollow spheres as a function of initial sphere radius with a density of 2.44 g/cm³. For the two densities of these models, a similar trend is observed that hollow spheres have a constant surface area above 1,400 m²/g, while the surface area of nano-onion solid spheres drop with an increase of sphere radius. FIGS. 4A and 4B provide a confirmation of the results of FIG. 3B, starting from different initial carbon densities. The above observations relating to the graphitization of amorphous carbon nanoparticles may be a basis for developing one or more structures of amorphous carbon precursors, which may be annealed to a single-layer graphitic structure at 3,000 K.

In one or more embodiments, the amorphous carbon precursor is a highly defected amorphous carbon nanocluster. The highly defected amorphous carbon nanocluster may have a high number of micropores (e.g., pores having a diameter of lower than 2 nanometers). The high number of micropores may be present in a range of 0.5 to 2.0 cm³/g. A percentage of removed mass of the amorphous carbon nanoparticles may be at least 70% for amorphous carbon nanoparticles with densities less than 2.5 g/cm³. The percentage of removed mass may be any of the following percentages or in a range of any two of the following percentages: 70%, 71%, 72%, 73%, 74%, 75%, 76%, 77%, 78%, 79%, 80%, 81%, 82%, 83%, 84%, 85%, 86%, 87%, 88%, 89%, and 90%. For amorphous carbon nanoparticles with densities greater than 2.5 g/cm³, the mass may be reduced by at least 80%. The percentage of removed mass may be any of the following percentages or in a range of any two of the following percentages: 80%, 81%, 82%, 83%, 84%, 85%, 86%, 87%, 88%, 89%, and 90%. For example, if the mass reduction is 80%, then 80% of the atoms may be ejected from the amorphous carbon structure by an ejection step using a technique such as ion bombardment or corrosion.

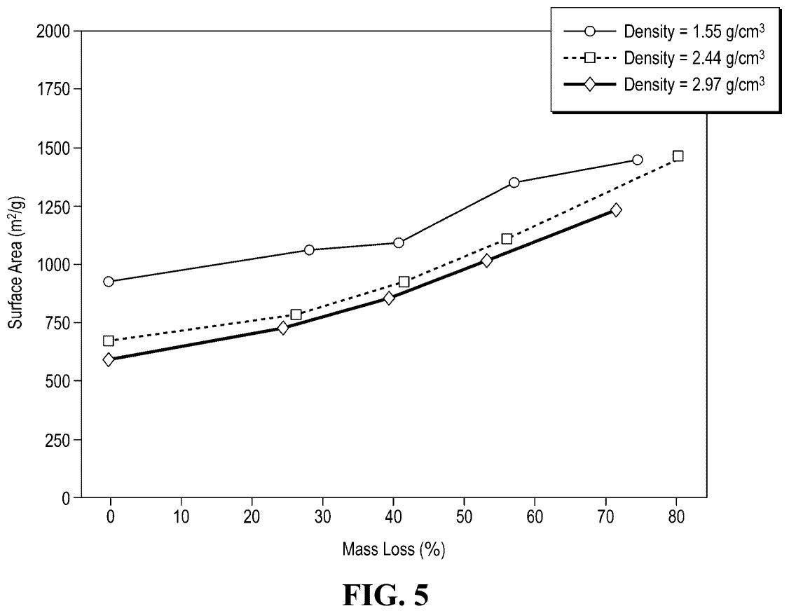

FIG. 5 depicts a graph of surface areas of graphitized carbon spheres with different mass loss. FIG. 5 demonstrates that a lower initial carbon mass results in a higher surface area and more graphitic carbon mesostructures. As shown in FIG. 5, the larger the percentage of mass loss, the higher the surface area after annealing at 3,000 K. In one or more embodiments, for amorphous carbon nanoparticles with a density less than 2.5 g/cm³, annealing of structures with mass loss of over 70% leads to structures with single graphitic walls and thereby a high surface area above 1,400 m²/g, comparable to that of graphitic hollow spheres with a single wall.

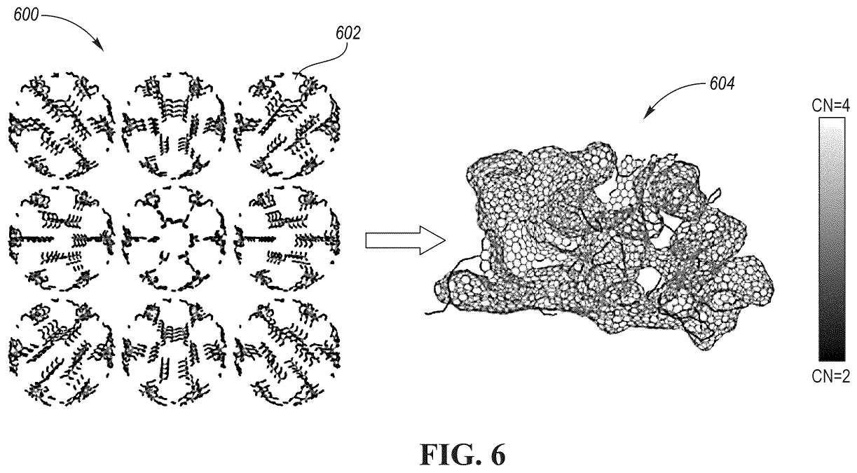

FIG. 6 depicts a schematic view of amorphous carbon spheres 600 with cylindrical defects 602 with a mass reduction of over 70% graphitized into single-layer graphitic carbon nanoclusters 604. In this embodiment, the carbon mesostructured is mostly single layer and entirely graphitic. Advanced experimental characterization techniques may be used to identify the mesostructured carbon structure. Non-limiting examples include transmission electron microscopy, Raman spectroscopy, and electron energy loss spectroscopy.

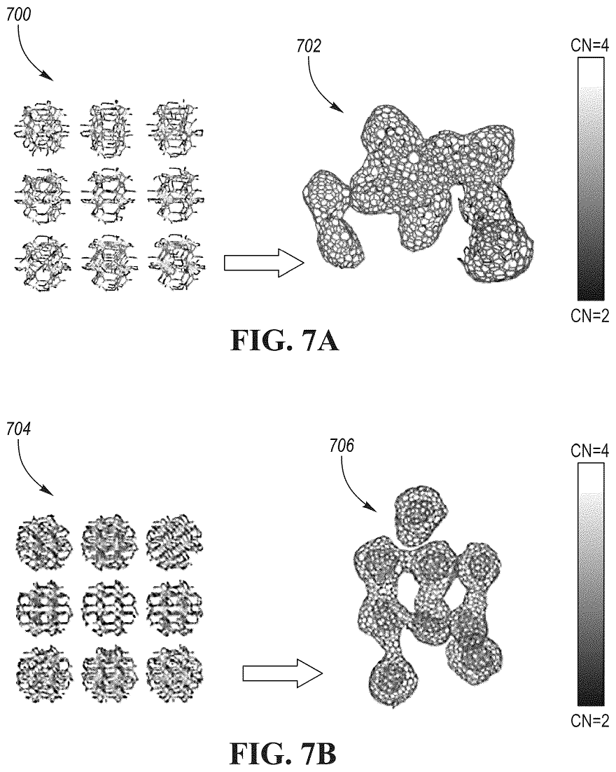

In one or more embodiments, the amorphous carbon precursors are amorphous carbon nanoclusters with an equivalent diameter less than 3 nanometers (e.g., less than 2 nanometers). FIG. 7A depicts a schematic view of amorphous carbon spheres 700 with a radius of about 0.8 nanometers graphitized into single-layer graphitic carbon nanoclusters 702. FIG. 7B depicts a schematic view of amorphous carbon spheres 704 with a radius of about 1.0 nm graphitized into double-layer graphitic carbon nanoclusters 706. Amorphous carbon spheres 700 and amorphous carbon spheres 704 may have an initial density of 2.44 g/cm³ at 2,500 K to 4,000 K (e.g., 3,000 K). In one or more embodiments, below a certain initial size (e.g., a radius of less than about 0.9 nanometers), an annealing step yields mostly single layer graphitic carbon mesostructures. This was observed even when no mass loss is introduced. In one or more embodiments, for larger initial radii (e.g., a radius larger than about 0.9 nanometers), the carbon mesostructured is graphitic but onion shaped.

As shown in FIG. 7B, amorphous carbon spheres 704 with a radius of about 1.0 nanometers graphitized into double-layer graphitic carbon nanoclusters 706. In one or more embodiments, to obtain a single-layer wall, the diameter of the amorphous carbon nanoparticle may be less than 2.0 nm depending on the initial density. For amorphous carbon nanoparticles with an initial density of 1.55 g/cm³ and 2.97 g/cm³, radii below 1.5 nanometers and 0.8 nanometers, respectively, may be used to obtain carbon nanoclusters with a single-layer wall after annealing at 2,500 K to 4,000 K (e.g., 3,000 K). The amorphous carbon nanoclusters may have an amorphous carbon nanocluster density of 1 to 1.6 g/cm³. When the amorphous carbon nanoclusters have an amorphous carbon nanocluster density of 1.6 to 2.4 g/cm³, the nominal nanocluster diameter may be less than 2 nanometers. When the amorphous carbon nanoclusters have an amorphous carbon nanocluster density of 2.4 to 3.0 g/cm³, the nominal nanocluster diameter may be less than 1.6 nanometers. The amorphous carbon nanoclusters may include defects.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A carbon precursor for use in fabricating a carbon support with a graphitic structure, the carbon graphitic structure precursor comprising:
defective amorphous carbon spheres having a mass loss percentage compared to defect-free amorphous carbon spheres, the defective amorphous carbon spheres are capable of fabricating a single-layer graphitic structure for use as the carbon support.

2. The carbon graphitic structure precursor of claim 1, wherein the defect-free amorphous carbon spheres density is less than 2.5 g/cm³ and the mass loss percentage is greater than 70%.

3. The carbon graphitic structure precursor of claim 1, wherein the defect-free amorphous carbon spheres density is greater than 2.5 g/cm³ and the mass loss percentage is greater than 80%.

4. The carbon graphitic structure precursor of claim 1, wherein the defective amorphous carbon spheres include defects.

5. The carbon graphitic structure precursor of claim 4, wherein in the defects are cylindrical defects.

6. The carbon graphitic structure precursor of claim 1, wherein the defective amorphous carbon spheres are defective amorphous carbon nanospheres.

7. The carbon graphitic structure precursor of claim 1, wherein the defect-free amorphous carbon spheres include hollow spheres.

8. The carbon graphitic structure precursor of claim 1, wherein the defective amorphous carbon spheres include micropores of lower than 2 nanometers in a range of 0.5 to 2.0 cm³/g.

9. A carbon precursor for use in fabricating a carbon support with a graphitic structure, the carbon graphitic structure precursor comprising:
amorphous carbon nanoclusters having a nominal nanocluster diameter of less than 3 nanometers, the amorphous carbon nanoclusters are capable of fabricating a single-layer graphitic structure for use as a carbon support.

10. The carbon graphitic structure precursor of claim 9, wherein the amorphous carbon nanoclusters have an amorphous carbon nanocluster density of 1 to 1.6 g/cm³.

11. The carbon graphitic structure precursor of claim 9, wherein the amorphous carbon nanoclusters have an amorphous carbon nanocluster density of 1.6 to 2.4 g/cm³ and the nominal nanocluster diameter is less than 2 nanometers.

12. The carbon graphitic structure precursor of claim 9, wherein the amorphous carbon nanoclusters have an amorphous carbon nanocluster density of 2.4 to 3.0 g/cm³ and the nominal nanocluster diameter is less than 1.6 nanometers.

13. The carbon graphitic structure precursor of claim 9, wherein the amorphous carbon nanoclusters include defects.

14. A method of fabricating a single-layer graphitic structure for use as a carbon support, the method comprising:
annealing amorphous carbon spheres to form a single-layer graphitic structure; and
forming the single-layer graphitic structure into the carbon support.

15. The method of claim 14, wherein the amorphous carbon spheres are defective amorphous carbon spheres, and further comprising forming the defective amorphous carbon spheres from starting amorphous carbon spheres.

16. The method of claim 15, wherein the forming step includes reducing the mass of the starting carbon spheres by a mass loss percentage to obtain the defective amorphous carbon spheres.

17. The method of claim 16, wherein the forming step includes ion bombarding the starting carbon spheres.

18. The method of claim 16, wherein the forming step includes corroding the starting carbon spheres.

19. The method of claim 14, wherein the single-layer graphitic structure is a single-layer graphitic shell.

20. The method of claim 14, wherein the carbon support is configured to support an electrocatalyst.
